(19) United States
(12) Patent Application Publication
(10) Pub. No.: US 2005/0271397 A1
(43) Pub. Date: Dec. 8, 2005

(54) Control circuitry in optoelectronic modules for laser crossing point adjustment

(76) Inventor: Phillip J. Edwards, San Jose, CA (US)

Correspondence Address: ROBERT A. PARSONS, 4000 N. CENTRAL AVENUE, SUITE 1220, PHOENIX, AZ, 85012, US

(21) Appl. No.: 11/143,276

(22) Filed: Jun. 1, 2005

Related U.S. Application Data
(60) Provisional application No. 60/575,872, filed on Jun. 1, 2004.

(51) Int. Cl. H04B 10/04

(52) U.S. Cl. 398/198

(57) ABSTRACT

A laser and a monitor photodiode providing a monitor signal. Laser driver circuitry has a data input terminal, a laser bias output terminal, a laser modulation output terminal, and a bias control input terminal. A processor having a bias control output terminal coupled to the bias control input terminal through an adjustable resistance for controlling the monitor signal from the photodiode, a modulation control output terminal coupled to a modulation setting input terminal through an adjustable resistance for controlling amplitude of modulation of the laser, and a modulation crossing point control output terminal coupled to a power adjustment input terminal of the laser driver circuitry through an adjustable resistance for adjusting modulation of the laser to achieve a desired crossing point in the optical output.

### CROSS-REFERENCE TO RELATED APPLICATION

This application claims the benefit of U.S. Provisional Application Ser. No. 60/575,872, filed 1 Jun. 2004.

### FIELD OF THE INVENTION

This invention relates to optoelectronic modules and, more particularly, to the cooperation between a laser and a power monitoring photodiode circuit in an optical communication system.

### BACKGROUND OF THE INVENTION

In optoelectronic modules used in the various communications fields, one of the most difficult problems that must be solved is the efficient transmission of light between a light generating device and an optical fiber. Here it will be understood by those skilled in the art that the term “light” is a generic term which includes any electromagnetic radiation that can be modulated and transmitted by optical fibers or other optical transmission lines.

Usually, the optical power of a semiconductor laser, is monitored and used in a feedback loop to control the laser to ensure a constant output from individual devices and to ensure a standard output between similar devices. Throughout this disclosure a laser is used as the primary example but it will be understood that other light sources may be utilized in other applications. Optical power monitoring is often done by placing a photodetector device proximate to the laser. A dc signal is then fedback to a laser driver in an attempt to maintain the output of the laser at a constant value.

Generally, the laser driver receives differential data, which is usually adjusted to a suitable amplitude by circuits included in the laser driver IC. The suitable amplitude of the driver output is selected or adjusted to achieve a desired ‘eye height’ in the optical output. In optoelectronic systems including monitor diodes, the optical output is usually derived from the summation of currents from the dc bias control loop and from the data modulation. The problem that arises is that the laser turn-on and turn-off times may not be identical and the crossing point between operation of the laser and the photodiode drive loop may be skewed or shifted from a nominal crossing point to a higher or lower crossing point, so that eye quality is changed. Also, temperature may affect the laser turn-on and turn-off times or other operating characteristics, thereby altering eye quality.

It would be highly advantageous, therefore, to remedy the foregoing and other deficiencies inherent in the prior art.

### SUMMARY OF THE INVENTION

Briefly, to achieve the desired objects of the instant invention in accordance with a preferred embodiment thereof, provided is control circuitry for laser crossing point adjustment including a laser for providing an optical output and a monitor photodiode positioned to monitor the laser and provide a monitor signal. The control circuitry also includes laser driver circuitry having a data input terminal, a bias output terminal coupled to the laser for supplying an operating bias to the laser, a modulation output terminal coupled to the laser for supplying a modulation signal to the laser, and a bias control input terminal coupled to the monitor photodiode for receiving the monitor signal from the photodiode. The control circuitry further includes a processor having a bias control output terminal coupled to the bias control input terminal of the laser driver circuitry for controlling the monitor signal from the photodiode. The processor also has a modulation control output terminal coupled to a modulation setting input terminal of the laser driver circuitry for controlling amplitude of modulation of the laser. The processor further has a modulation crossing point control output terminal coupled to a power adjustment input terminal of the laser driver circuitry for adjusting modulation of the laser to achieve a desired crossing point in the optical output.

### BRIEF DESCRIPTION OF THE DRAWINGS

The foregoing and further and more specific objects and advantages of the invention will become readily apparent to those skilled in the art from the following detailed description of a preferred embodiment thereof, taken in conjunction with the drawings in which:

FIG. 1 is a schematic/block diagram of an optoelectronic module in accordance with the present invention; and

FIG. 2 is a simplified representation of a shift in symmetry of the crossing point of a laser/photodiode eye.

### DETAILED DESCRIPTION OF THE DRAWINGS

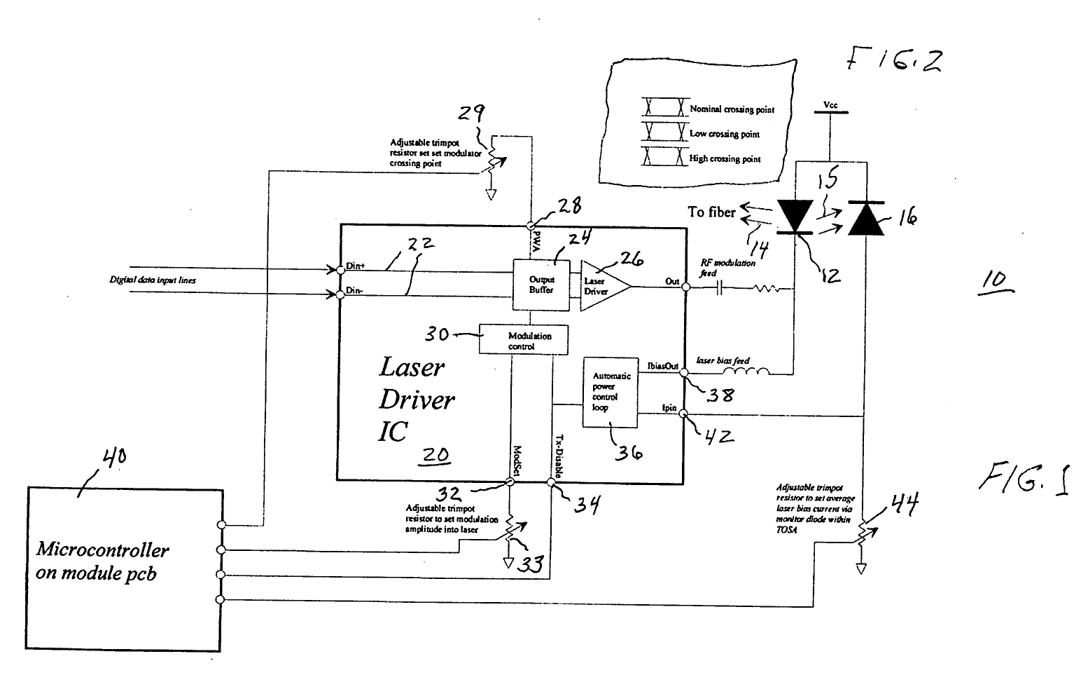

Turning now to FIG. 1, an optoelectronic transmitter 10 in an optoelectronic module is illustrated. Transmitter 10 includes a light source, in this specific embodiment laser 12, that emits light 14 into an optical fiber (not shown) and light 15 to a transmitter optical sub assembly (TOSA) monitor photodiode 16. Here it will be understood that light 14 and 15 may be the same light (e.g. light transmitted in a common direction) or light transmitted from laser 12 in opposite directions from opposite sides or ends.

Laser 12 is coupled to a laser driver integrated circuit (IC) 20 that is usually mounted on a printed circuit board in the optoelectronic module. Laser driver IC 20 is connected to receive differential data on a pair of input lines 22 for transmission to a remote destination (i.e. the opposite end of the optical fiber). Input lines 22 are connected through an output buffer 24 to a laser driver 26. It will of course be understood that output buffer 24 and laser driver 26 are illustrated only for purposes of this explanation and various embodiments may include more or less circuits and circuitry, depending upon the specific application. An output of laser driver 26 is coupled through an RF pass filter 27 (e.g. a series connected capacitor and resistor, designed to pass RF and block dc) to the signal input of laser 12. Output buffer 24 also has a power adjustment input (PWA) connected to an I/O terminal 28 of laser driver IC 20. I/O terminal 28 of laser driver IC 20 is coupled through an adjustable trimpot resistor 29 to a common return, such as ground. Trimpot resistor 29 is controlled by a microcontroller or microprocessor, hereinafter processor 40, that is mounted on the printed circuit board in the optoelectronic module, as will be described in more detail below.

A modulation control circuit 30 is connected to another input of output buffer 24 to provide a control over the amount of modulation performed within laser 12. Modulation control circuit 30 has a ModSet input terminal, for receiving a modulation setting signal, and a Tx-Disable input terminal, for receiving a transmission disable signal, connected to I/O terminals 32 and 34, respectively, of laser driver IC 20. I/O terminal 32 is connected through an adjustable trimpot resistor 33 to a common return (e.g. ground). Trimpot resistor 33 is controlled by processor 40, as will be described in more detail below. I/O terminal 34, in this embodiment, is connected to processor 40 for receiving transmission disable signals and, conversely, enable signals.

An automatic power control loop circuit 36 has a bias output terminal 38 connected through a dc pass filter circuit (e.g. a low frequency inductance, designed to pass dc and block RF) to the drive input of laser 12 for supplying dc bias current to laser 12. Automatic power control loop circuit 36 has a control input terminal 42 connected to photodiode 16 for supplying a control signal to power control loop circuit 36 that is used to determine the amount of bias current supplied to laser 12. Control input terminal 42 and the output of photodiode 16 are connected through an adjustable trimpot resistor 44 to a common return point (e.g. ground). Trimpot resistor 44 is controlled by processor 40, as will be described in more detail below. Tx-Disable input terminal 34 is also connected to a control input of power control loop circuit 36 to disable circuit 36 when modulation control circuit 30 is disabled.

It should be understood by those skilled in the art that processor 40, in many instances, is already available on the printed circuit board in the optoelectronic module. For example, the processor may be communicating status to the ‘outside world’, it may be controlling data flow through the module from directives from ‘outside the module’, or it may simply be mapping optimal control points across temperature. Thus, in most instances, a new or different microprocessor or microcontroller is not required for this invention. While it will be understood that adjustable resistors other than the disclosed adjustable trimpot resistors can be used, if desired, in many instances adjustable trimpot resistors are already used on the printed circuit board in the optoelectronic module and the same or additional adjustable trimpot resistors can easily be incorporated.

Differential data is fed into laser driver IC 20 per usual convention. Only when laser driver IC 20 is told to enable its outputs via Tx-Disable input terminal 34, which may be driven through processor 40 or directly from a remote source, does power control loop circuit 36 initialize and try to find a stable operating point, where the photocurrent from power monitor diode 16 is used to feed transmitted optical power information back to laser driver IC 20 so that a ‘target’ optical power can be hunted and laser 12 biased accordingly. The conversion from photocurrent to laser driver IC 20 control input terminal 42 is via adjustable trimpot resistor 44, which may or may not be temperature compensated.

The optical output is usually derived from the summation of currents including the dc bias from control loop circuit 36 and from the data modulation signal by way of laser driver 26. The differential driven modulation is normally adjusted to a suitable amplitude by laser driver IC 20, to achieve the desired ‘eye height’ in the optical output. In this embodiment, the modulation is adjusted by processor 40, through adjustable trimpot resistor 29. The effect of adjusting the crossing point of the eye is illustrated in FIG. 2, which illustrates nominal, low, and high crossing points, respectively. The symmetry of the eye is skewed depending upon the amount of pre-distortion applied to the assumed perfect data stream coming into laser driver IC 20 by way of input lines 22. This skew is sometimes desirable to compensate for laser turn-on and turn-off timing not being identical, or in some cases a shift in the symmetry of the eye can achieve a better ‘mask margin’, which is a typical figure of merit for an optical source. In this invention, the control of the crossing point is taken by processor 40 and is thus adjustable via the software. This enables fine tuning of the shape of the transmitted optical eye, as a function of whatever is required, e.g. temperature control, mask margin optimization, jitter control, etc., to allow for superior transmit eye performance.

Thus, new and improved control circuitry for a light source in optoelectronic modules has been disclosed. In the preferred embodiment, the control circuitry includes a microprocessor or microcontroller that is already resident on the module printed circuit board. Also, in the preferred embodiment adjustable trimpot resistors are used and controlled by the processor. Since adjustable trimpot resistors are usually used on optoelectronic modules, this does not entail the use of new and different components. Thus, the present invention is easy to incorporate into new or already operating modules.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. Control circuitry for laser crossing point adjustment comprising:
a laser for providing an optical output;
a monitor photodiode positioned to monitor the laser and provide a monitor signal;
laser driver circuitry having a data input terminal, a bias output terminal coupled to the laser for supplying an operating bias to the laser, a modulation output terminal coupled to the laser for supplying a modulation signal to the laser, and a bias control input terminal coupled to the monitor photodiode for receiving the monitor signal from the photodiode;
a processor having a bias control output terminal coupled to the bias control input terminal of the laser driver circuitry for adjusting the monitor signal from the photodiode;
the processor having a modulation control output terminal coupled to a modulation setting input terminal of the laser driver circuitry for controlling amplitude of modulation of the laser; and
the processor having a modulation crossing point control output terminal coupled to a power adjustment input terminal of the laser driver circuitry for adjusting modulation of the laser to achieve a desired crossing point in the optical output.

2. Control circuitry as claimed in claim 1 wherein the bias control output terminal of the processor is coupled to the bias control input terminal of the laser driver circuitry through an adjustable resistance.

3. Control circuitry as claimed in claim 2 wherein the bias control input terminal of the laser driver circuitry is connected to a common return through an adjustable resistance and the bias control output terminal of the processor is coupled to control the adjustable resistance.

4. Control circuitry as claimed in claim 1 wherein the modulation control output terminal of the processor is coupled to the modulation setting input terminal of the laser driver circuitry through an adjustable resistance.

5. Control circuitry as claimed in claim 4 wherein the modulation setting input terminal of the laser driver circuitry is connected to a common return through an adjustable resistance and the modulation control output terminal of the processor is coupled to control the adjustable resistance.

6. Control circuitry as claimed in claim 1 wherein the modulation crossing point control output terminal of the processor is coupled to the power adjustment input terminal of the laser driver circuitry through an adjustable resistance.

7. Control circuitry as claimed in claim 6 wherein the power adjustment input terminal of the laser driver circuitry is connected to a common return through an adjustable resistance and the modulation crossing point control output terminal of the processor is coupled to control the adjustable resistance.

8. Control circuitry as claimed in claim 6 wherein the adjustable resistance includes digital to analog conversion apparatus.

9. Control circuitry as claimed in claim 8 wherein the digital to analog conversion apparatus includes a digital to analog converter, a digital trimpot, a pulse width modulation open collector output coupled to a fixed value R-C low pass filter connected to emulate a variable resistor.

10. Control circuitry as claimed in claim 1 wherein the the bias control output terminal of the processor is coupled to the bias control input terminal of the laser driver circuitry through an adjustable trimpot resistor, the modulation control output terminal of the processor is coupled to the modulation setting input terminal of the laser driver circuitry through an adjustable trimpot resistor, and the modulation crossing point control output terminal of the processor is coupled to the power adjustment input terminal of the laser driver circuitry through an adjustable trimpot resistor.

11. Control circuitry for laser crossing point adjustment comprising:
a laser for providing an optical output;
a monitor photodiode positioned to monitor the laser and provide a monitor signal;
laser driver circuitry having a data input terminal, a bias output terminal coupled to the laser for supplying an operating bias to the laser, a modulation output terminal coupled to the laser for supplying a modulation signal to the laser, and a bias control input terminal coupled to the monitor photodiode for receiving the monitor signal from the photodiode;
a processor having a bias control output terminal coupled to the bias control input terminal of the laser driver circuitry through an adjustable resistance for controlling the monitor signal from the photodiode;
the processor having a modulation control output terminal coupled to a modulation setting input terminal of the laser driver circuitry through an adjustable resistance for controlling amplitude of modulation of the laser; and
the processor having a modulation crossing point control output terminal coupled to a power adjustment input terminal of the laser driver circuitry through an adjustable resistance for adjusting modulation of the laser to achieve a desired crossing point in the optical output.

12. A method of adjusting a laser crossing point in optoelectronic modules comprising the steps of:
providing an optoelectronic module including a laser for providing an optical output, a monitor photodiode positioned to monitor the laser and provide a monitor signal, laser driver circuitry having a data input terminal, a bias output terminal coupled to the laser for supplying an operating bias to the laser, a modulation output terminal coupled to the laser for supplying a modulation signal to the laser, and a bias control input terminal coupled to the monitor photodiode for receiving the monitor signal from the photodiode, and a processor;
supplying a bias control output signal from the processor to the bias control input terminal of the laser driver circuitry for controlling the monitor signal from the photodiode;
supplying a modulation control output signal from the processor to a modulation setting input terminal of the laser driver circuitry for controlling amplitude of modulation of the laser; and
supplying a modulation crossing point control signal from the processor to a power adjustment input terminal of the laser driver circuitry for adjusting modulation of the laser to achieve a desired crossing point in the optical output.

13. A method as claimed in claim 12 wherein the step of supplying a bias control output signal from the processor to the bias control input terminal of the laser driver circuitry includes connecting the bias control input terminal of the laser driver circuitry to a common return through a variable resistance.

14. A method as claimed in claim 13 including a step of using the bias control output signal from the processor to control the variable resistance.

15. A method as claimed in claim 12 wherein the step of supplying a modulation control output signal from the processor to a modulation setting input terminal of the laser driver circuitry includes connecting the modulation setting input terminal of the laser driver circuitry to a common return through a variable resistance.

16. A method as claimed in claim 15 including a step of using the modulation control output signal from the processor to control the variable resistance.

17. A method as claimed in claim 15 wherein the step of supplying a modulation crossing point control signal from the processor to a power adjustment input terminal of the laser driver circuitry includes connecting the power adjustment input terminal of the laser driver circuitry to a common return through a variable resistance.

18. A method as claimed in claim 17 including a step of using the modulation crossing point control signal from the processor to control the variable resistance.

19. A method of adjusting a laser crossing point in optoelectronic modules comprising the steps of:
providing an optoelectronic module including a laser for providing an optical output, a monitor photodiode positioned to monitor the laser and provide a monitor signal, laser driver circuitry having a data input terminal, a bias output terminal coupled to the laser for supplying an operating bias to the laser, a modulation output terminal coupled to the laser for supplying a modulation signal to the laser, and a bias control input terminal coupled to the monitor photodiode for receiving the monitor signal from the photodiode, and a processor;
controlling the monitor signal from the photodiode by controlling a bias control output signal supplied from the processor to the bias control input terminal of the laser driver circuitry;
controlling amplitude of modulation of the laser by controlling a modulation control output signal supplied from the processor to a modulation setting input terminal of the laser driver circuitry; and
adjusting modulation of the laser to a desired crossing point in the optical output by controlling a modulation crossing point control signal supplied from the processor to a power adjustment input terminal of the laser driver circuitry.

20. A method as claimed in claim 19 wherein the step of controlling the monitor signal includes connecting the bias control input terminal of the laser driver circuitry to a common return through a variable resistance and using the processor to control the variable resistance.

21. A method as claimed in claim 19 wherein the step of controlling amplitude of modulation of the laser includes connecting the modulation setting input terminal of the laser driver circuitry to a common return through a variable resistance and using the processor to control the variable resistance.

22. A method as claimed in claim 19 wherein the step of adjusting modulation of the laser to a desired crossing point includes connecting the power adjustment input terminal of the laser driver circuitry to a common return through a variable resistance and using the processor to control the variable resistance.
